(19) United States
(12) Patent Application Publication
(10) Pub. No.: US 2007/0160206 A1
(43) Pub. Date: Jul. 12, 2007

(54) Communication method for remote keyless entry system

(75) Inventors: Gerald Ostrander, Davison, MI (US); David J. Reimus, West Bloomfield, MI (US); Tejas Desai, Troy, MI (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens VDO Automotive Corporation, Auburn Hills, MI (US)

(21) Appl. No.: 11/651,233

(22) Filed: Jan. 9, 2007

Related U.S. Application Data
(60) Provisional application No. 60/758,053, filed on Jan. 11, 2006.
(60) Provisional application No. 60/758,052, filed on Jan. 11, 2006.

(51) Int. Cl. H04L 9/32; H04N 7/167; G06K 9/00; G06F 17/30; G06F 7/04

(52) U.S. Cl. 380/203; 726/2; 380/220; 380/238

(57) ABSTRACT

A system and method provides a wireless link that is adaptive to the current electronic environment. An electronic control unit monitors signals that are proximate the vehicle that make up the current electronic environment. The electronic control unit evaluates these signals along with any other signals proximate the vehicle. The evaluation of the signals includes the determination of a best signal modulation and strength that would best avoid potential interferences with the other signals. The determined transmission protocol is sent in the prompt signal to an authentication device. The authentication device in return transmits the identifier signal according to the determined transmission protocol.

### CROSS REFERENCE TO RELATED APPLICATION

The application claims priority to U.S. Provisional Application Nos. 60/758,053 and 60/758,052 which were both filed on Jan. 11, 2006.

### BACKGROUND OF THE INVENTION

This invention generally relates to a method of communicating between an passive entry authentication device and a receiver within an automobile. More particularly, this invention relates to a method of tailoring communication protocol between an entry authentication device and a receiver to the electronic environment.

A passive entry system includes a receiver that is part of a controller for controlling access control devices. The receiver receives a signal from an entry authentication device in response to a prompt signal. The prompt signal is transmitted from the system, within an automobile for example, and is received by the entry authentication device. The prompt signal is typically a low frequency signal that is not easily disruptable. The entry authentication device receives this signal and transmits a radio frequency (RF) signal including a code or other identification that communicates to the system that an authorized user is present. The system is then actuated to allow access to a known authenticated user.

The authentication device typically transmits a signal that is of a fixed frequency and modulation. This signal does not change and is recognized by the specific receiver that corresponds to the system of which the authentication device belongs. Increasing numbers of electronic devices are becoming a common part of daily life and activity. Many electronic signals are emitted from various communication devices creating an electronic environment. Radio towers emit strong RF signals to increase listening range. Garage door openers emit signals to authenticate a known door opening device. Further, many more vehicles are including passive authentication systems that virtually eliminate the use and need for a key.

Disadvantageously, all of these signals are potential causes of interference for the RF signal emitted by the entry authentication device. The interference can limit or completely impair the communication with a passive authentication system. Such impaired communication is an undesirable disruption and potential source of customer dissatisfaction.

Accordingly, it is desirable to design and develop a device and method of communicating that overcomes potential disturbances in communication between a passive entry authentication device and passive entry system.

### SUMMARY OF THE INVENTION

An example system and method provides a wireless link that is adaptive to the current electronic environment.

An example system includes an electronic control unit for an access authorization system of a vehicle. A user carries an access authentication device that communicates with the ECU through a wireless link. The wireless link includes a prompt signal that is transmitted from the vehicle to the authentication device and an identifier signal transmitted form the authentication device back to the ECU. The example authentication device includes a code or identification number that corresponds with a stored and known code within the ECU. In response to the correct code being received, the access authorization system allows access and operation of the various controlled features of the vehicle.

The environment in which the vehicle operates often includes other electronic devices that transmits signals that could potential interfere with the wireless link. The example ECU monitors signals that are proximate the vehicle that make up the current electronic environment. The ECU evaluates these signals along with any other signals proximate the vehicle. The evaluation of the signals includes the determination of a best signal modulation and strength that would best avoid potential interferences with the other signals. The determined transmission protocol is sent in the prompt signal to the authentication device. The authentication device in return transmits the identifier signal according to the determined transmission protocol.

The process of monitoring and evaluation repeats so that the identifier signal is continually adapted to the surrounding environment to reduce the possibility of interference with the identifier signal. Accordingly, the example method and system provides a robust wireless link that adapts to current environmental conditions to utilize a most favorable transmission protocol in view of the current electronic environment.

These and other features of the present invention can be best understood from the following specification and drawings, the following of which is a brief description.

### BRIEF DESCRIPTION OF THE DRAWINGS

FIG. 1 is a schematic diagram of an example wireless system.

### DETAILED DESCRIPTION OF THE PREFERRED EMBODIMENT

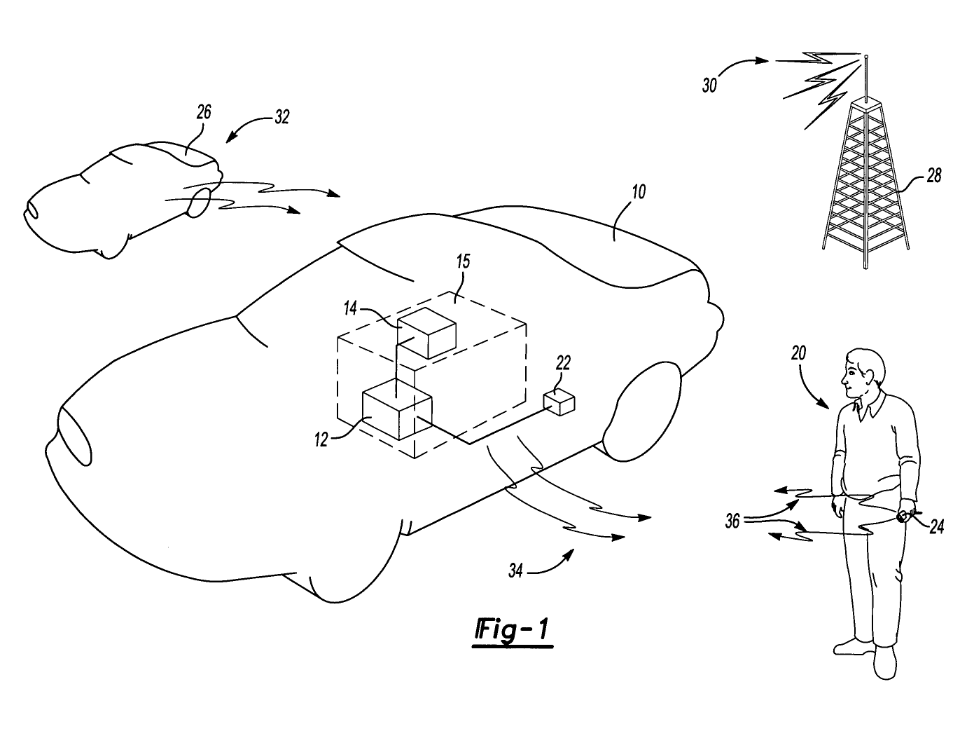

Referring to FIG. 1, an example vehicle 10 includes a controller 12 that communicates with a receiver 14 and controls actuation of an access control device 22. The receiver 14 and controller 12 are part of an electronic control unit (ECU) 15 of an access authorization system for the vehicle 10. The access authorization system provides for the access and operation of the vehicle 10 by authorized users. The example system controls the access control device 22 that is for example a door lock. Other access control devices 22 for a vehicle such as a trunk or ignition switch are also within the contemplation of this invention. Further, the ECU 15 may be a stand alone unit or may be a part of another vehicle control system or device.

A user 20 carries an access authentication device 24 that communicates with the ECU 15 through a wireless link. The wireless link includes a prompt signal 34 that is transmitted from the vehicle 10 to the authentication device 24. In response to the prompt signal 34, the authentication device 24 transmits an identifier signal 36 back to the ECU 15. The authentication device 24 includes a code or identification number that corresponds with a stored and known code within the ECU 15. In response to the correct code being received, the access authorization system allows access and operation of the various controlled features of the vehicle 10.

The environment in which the vehicle 10 operates often includes other electronic devices such as other vehicles 26 or radio transmission towers 28. The tower transmits electronic signals 30 that can interfere with the identifier signal 36. Further, the other vehicle 26 may also include a wireless access control system that transmits signals 32. As appreciated, many other devices, and systems are being installed and are becoming increasingly common in daily activities that transmit signals. The many different signals potentially interfere with the identifier signal 36 that is transmitted from the user authentication device 24. Such interferences are not desirable.

The example ECU 15 monitors signals that are proximate the vehicle 10 that make up the current electronic environment. The electronic environment proximate the vehicle 10 can include the transmissions 30 from the radio tower 28, signals 32 from other vehicles or any other signal that is generated and present within the proximity of the vehicle 10. The receiver 14 and controller 12 evaluate the signals 30, 32 along with any other signals proximate the vehicle. The evaluation of the signals includes the determination of a best signal modulation and strength that would best avoid potential interferences with the other signals.

Information concerning other signals and transmissions proximate the vehicle 10 that make up the electronic environment is utilized to determine a desired transmission protocol from the user authentication device 24. This determination can include a modulation format, desired frequency and power levels. The authentication device 24 will then transmit the identifier signal 36 according to the transmission protocol as instructed in the prompt signal 34.

The example prompt signal 34 is a low frequency signal that is robust and not subject to interference by other signals that make up the surrounding electronic environment. Although the example prompt signal 34 is of a low frequency, other transmission modulations and protocols that are not subject to interference from surrounding electronic devices can also be used.

The example identifier signal 36 from the authentication device 24 is adaptive to the proximate electronic environment and is capable of transmitting in several different frequencies and power levels. The example authentication device 24 is illustrated as a key fob device. However, other passive or active authentication devices as are known in the art are within the contemplation of this invention. The example authentication device 24 transmits automatically responsive to the prompt signal so that the user 20 is not required to take any action such as for example pushing a specific button. All that is required is that the user 20 be proximate to the vehicle 10 so that the identifier signal 36 can be received by the ECU 15.

In operation, the ECU 15 monitors electronic signals in the proximate environment such as the example signals 32 from another vehicle, or from radio signals from a nearby radio tower 28. The ECU 15 need not be on continually, but can instead be cycled on and off periodically. The ECU 15 cycles on and receives signals to evaluate the current electronic environment. The electronic environment includes the many other signals of various frequencies and modulations. The ECU 15 need not evaluate or monitor all frequencies or transmissions, but only those within the spectrum that the identifier signal 36 would be transmitted.

The information obtained by the ECU 15 regarding surrounding electronic signals is utilized to determine a desired transmission protocol for the authentication device 24. The transmission protocol is determined to provide a desired transmission that is less subject to potential interference from the current surrounding electronic environment.

The example identifier signal 36 can be of a Frequency Shift Keyed modulation or an Amplitude Shift Keyed modulation depending on the current electronic environment. Further, strength of the identifier signal 36 can be adapted to the surroundings to provide a transmission that is least susceptible to interference from the detected surrounding electronic environment.

The process of monitoring and evaluation repeats so that the identifier signal 34 is continually adapted to the surrounding environment to reduce the possibility of interference with the identifier signal 36. Accordingly, the example method and system provides a robust wireless link that adapts to current environmental conditions to always utilize the most favorable transmission protocol in view of the current electronic environment.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A passive entry authentication system comprising:
a controller that transmits a prompt signal; and
an entry authentication device that transmits an identifier signal responsive to receipt of the prompt signal, wherein the transmitted prompt signal includes instructions specifying a transmission protocol of the identifier signal that is transmitted to the controller.

2. The system as recited in claim 1, wherein the controller includes a receiver for receiving the identifier signal and for monitoring transmissions that may interfere with the identifier signal.

3. The system as recited in claim 2, wherein controller monitors local transmissions and determines a transmission protocol for the identifier signal responsive to the local transmissions.

4. The system as recited in claim 1, wherein the transmission protocol comprises one of a plurality of frequencies.

5. The system as recited in claim 1, wherein the transmission protocol comprises one of a plurality of different signal modulations.

6. The system as recited in claim 5, wherein the plurality of different signal modulations includes frequency shift keyed modulation and amplitude shift keyed modulation.

7. The system as recited in claim 1, wherein the prompt signal comprise a low frequency signal.

8. The system as recited in claim 1, wherein the identifier signal comprises a radio frequency signal.

9. A method of communicating between a controller within a vehicle and an authentication device comprising the steps of:
a) sending a prompt signal from a vehicle to an authentication device, wherein the prompt signal communicates a desired transmission protocol to the authentication device; and
b) sending an identifier signal from the authentication device to the vehicle, wherein the identifier signal is transmitted according to the desired transmission protocol communicated from the vehicle.

10. The method as recited in claim 9, including the step of monitoring transmissions present proximate the vehicle and evaluating the monitored transmissions for potential interference with the identifier signal.

11. The method as recited in claim 10, including the step of determining a desired transmission protocol based in part on the evaluated transmissions proximate the vehicle.

12. The method as recited in claim 11, wherein the transmission protocol is selected responsive to other communications present proximate the vehicle.

13. The method as recited in claim 9, wherein the prompt signal comprises a low frequency transmission.

14. The method as recited in claim 9, wherein the identifier signal is a radio frequency signal of frequency greater than the prompt signal.

15. The method as recited in claim 9, wherein the identifier signal comprises a Frequency Shift Keyed modulation.

16. The method as recited in claim 9, wherein the identifier signal comprises an Amplitude Shift Keyed modulation.
